(19) United States
(12) Patent Application Publication
(10) Pub. No.: US 2012/0253597 A1
(43) Pub. Date: Oct. 4, 2012

(54) INFORMATION DISPLAY SYSTEM, ON-BOARD DEVICE, AND PORTABLE DEVICE

(75) Inventors: Toru Nada, Inazawa-city (JP); Takeshi Yamamoto, Anjo-city (JP)

(73) Assignee: DENSO CORPORATION, Kariya-city (JP)

(21) Appl. No.: 13/438,194

(22) Filed: Apr. 3, 2012

(30) Foreign Application Priority Data
Apr. 4, 2011 (JP) 2011-082900

(51) Int. Cl. G06F 7/00

(52) U.S. Cl. 701/36; 701/1

(57) ABSTRACT

An information display system is disclosed. The information display system comprises an on-board device configured to control a plurality of in-vehicle apparatuses, and a portable device including a portable display. The on-board device and the portable device are configured to communicate with each other for data exchange. The on-board device includes an apparatus information sending section configured to send apparatus information, which is information on the plurality of in-vehicle apparatuses. The portable device includes a portable display control section configured to display the apparatus information, which is sent from the apparatus information sending section, on the portable display.

### CROSS REFERENCE TO RELATED APPLICATION

The present application is based on and claims priority to Japanese Patent Application No. 2011-82900 filed on Apr. 4, 2011, disclosure of which is incorporated herein by reference.

### TECHNICAL FIELD

The present disclosure relates to an information display system comprising an on-board device for controlling multiple in-vehicle apparatuses and a portable device including a portable display. The on-board device and the portable device can perform data communications with each other.

### BACKGROUND

A known display system for a vehicle displays information about in-vehicle apparatus such as a navigation apparatus, an air conditioner and the like on a display screen of a display mounted to a vehicle (also referred to as “an in-vehicle display”). A liquid crystal display (LCD) may be used for the display screen.

In a known system, a user can input a command to an in-vehicle apparatus by pointing to a certain position on the display screen of the in-vehicle display. In this system, the LCD displays an icon, a button or the like. A user operates the in-vehicle apparatus by pointing to the icon, a button or the like.

In recent years, in accordance with sophistication of in-vehicle apparatuses, an amount of information and an amount of operation relating to in-vehicle apparatuses are increasing. Therefore, in order to display the information about in-vehicle apparatuses and operate the in-vehicle apparatuses, a user needs to frequently switch the display screen. As a result, an amount of user's operation is increasing.

In this relation, it is conceivable that when the number of in-vehicle displays is increased, it becomes possible to provide a lot of information in parallel. In this regard, an apparatus for configuring a detachable in-vehicle display is proposed (e.g., JP-2004-130894A). According to this apparatus, multiple in-vehicle displays can be attached to the apparatus, so that the multiple in-vehicle displays can be used for information display and operation.

However, although the above technique enables mounting the multiple in-vehicle displays, a user needs to purchase the multiple in-vehicle displays and pay a high cost.

### SUMMARY

In view of the foregoing, it is an object of the present disclosure to provide an information display system, an on-board device, and a portable device that can efficiently provide information without requiring a user to purchase a new in-vehicle display.

According to an example of the present disclosure, an information display system comprises an on-board device configured to control a plurality of in-vehicle apparatuses, and a portable device including a portable display. The on-board device and the portable device are configured to communicate with each other for data exchange. The on-board device includes an apparatus information sending section configured to send apparatus information, which is information on the plurality of in-vehicle apparatuses. The portable device includes a portable display control section configured to display the apparatus information, which is sent from the apparatus information sending section, on the portable display.

According to the above information display system, the on-board device and the portable device, it is possible to efficiently provide information without requiring new purchases of an in-vehicle display.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram illustrating an information display system;

FIG. 2 is an on-board device and a portable device connected with a network data center;

FIG. 3 is a flowchart illustrating a software sending process;

FIG. 4 is a flowchart illustrating an apparatus information sending processes;

FIG. 5 is a flowchart illustrating an apparatus information receipt process;

FIGS. 6A and 6B are diagrams illustrating display examples;

FIG. 7 is a flowchart illustrating a portable information sending process;

FIG. 8 is a flowchart illustrating a portable information receipt process; and

FIG. 9A to 9C are diagrams illustrating other display examples.

### DETAILED DESCRIPTION

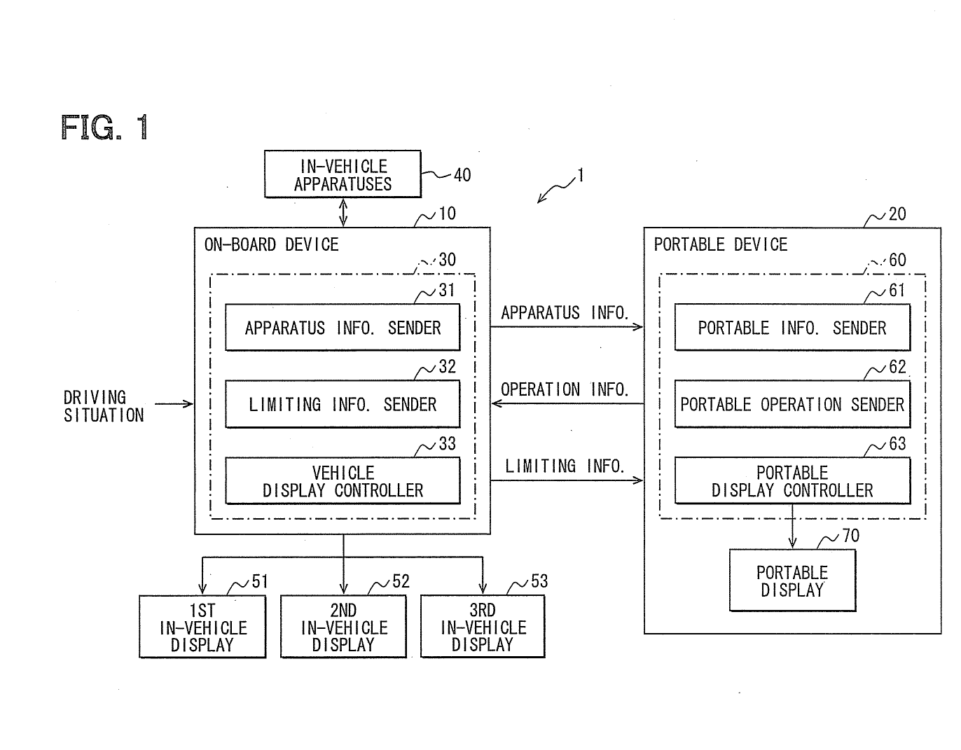

Embodiments will be described with reference to the accompany drawings. FIG. 1 is a block diagram illustrating a configuration of an information display system 1 of one embodiment. The information display system 1 includes an on-board device 10 and a portable device 20, which are connected with each other to enable data exchange therebetween. The on-board device 10 and the portable device 20 may be coupled by a wired connection or wireless connection. For example, serial bus standards such as USB (Universal Serial Bus) or the like may be used. Alternatively. Bluetooth standards or the like may be used.

The on-board device 10 may include a computer with a processor, a memory and the like. By executing a programs 30 (software) installed in the on-board device 10, the processor may implement functions of the on-board device 10. The on-board device 10 includes an apparatus information sending section 31, a restriction information sending section 32, and a vehicle display control section 33, which may be functional blocks of the software 30.

Multiple in-vehicle apparatuses 40 are connected to the on-board device 10, which controls the in-vehicle apparatuses 40. The multiple in-vehicle apparatuses 40 include a navigation apparatus, an air conditioner, an audio apparatus etc. Three in-vehicle displays 51, 52, 53 are connected to the on-board device 10. The vehicle display control section 33 can display Information about the multiple in-vehicle apparatuses 40 on the in-vehicle displays 51, 52, 53.

In order to distinguish the three in-vehicle displays 51, 52, 53, the three in-vehicle displays 51, 52, 53 may be, respectively called a first in-vehicle display 51, a second in-vehicle display 52, and a third in-vehicle display 53 on an as-needed basis.

The on-board device 10 receives information about a driving situation. For example, the information about a driving situation may be outputted from an environment situation detector (not shown) including a vehicle motion sensor, an acceleration sensor, a physical/emotion condition sensor, or the like. The vehicle motion sensor detects a steering state, an accelerator pedal state, a brake pedal state, a blinker state, a transmission state (e.g., shift lever state) or the like. The acceleration sensor detects acceleration in a heading direction of the vehicle, and acceleration in a left-to-right direction of the vehicle. The physical/emotion condition sensor detects driver's eyelid motion, driver's heart rate, or the like. Because of the above configuration, the on-board device 10 can calculate and quantify a driver's burden in a driving the vehicle. For example, in situations of a large amount of driver's driving operation, the driver's burden is calculated to be a relatively large numerical value. In situations where the motion of the driver's eyelid is slow or the heart rate of the driver is large, the driver's burden is calculated to be a relatively large numerical value.

The portable device 20 may include a computer with a processor, a memory and the like. By executing a programs 60 (software) installed in the portable device 20, the processor may implement functions of the portable device 20. The portable device 20 includes a portable information sending section 61, a portable operation sending section 62, and a portable display control section 63, which may be functional blocks of the portable device 20. The portable device 20 further includes a portable display 70. The portable display 70 may be a liquid crystal display integrated with a touch panel. This configuration enables a display-based touch operation.

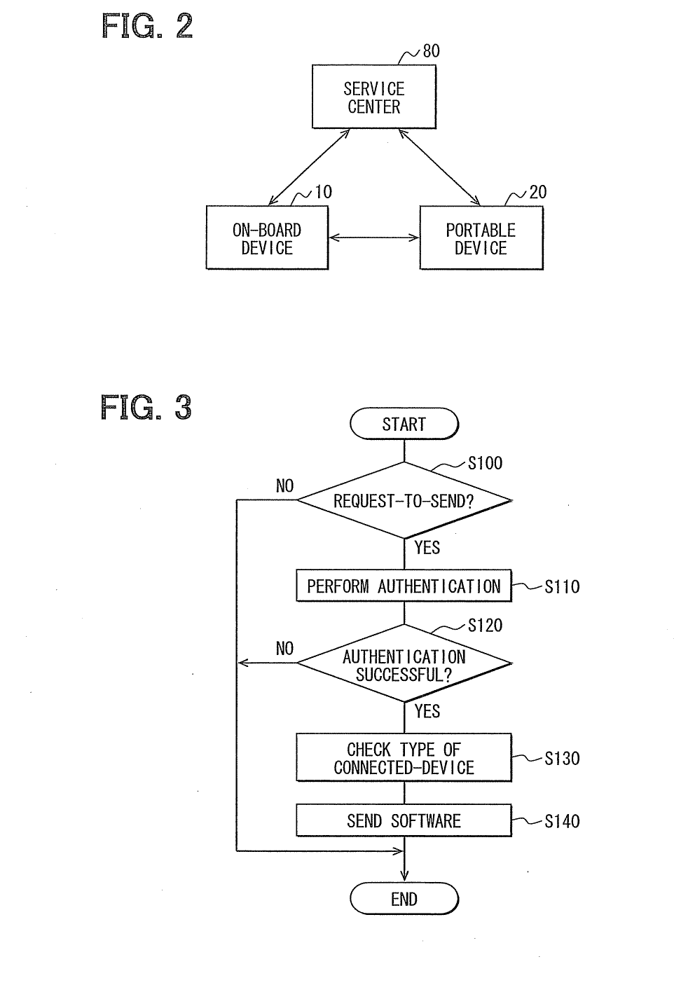

Next, explanation will be given on how to acquire the software 30 for an on-board device and the software 60 for a portable device. As shown in FIG. 2, the on-board device 10 and the portable device 20 in the information display system 1 are connectable to a network service center 80 to perform data communications.

The network service center 80 includes a server on the Internet. The on-board device 10 and the portable device 20 can acquire necessary information over the Internet. Specifically, the software 30 and the software 60 can be downloaded from the network service center 80.

A software sending process performed by the network service center 80 will be described with reference to FIG. 3. The network service center 80 cyclically performs the software sending process at predetermined time intervals. In the following, explanation is given on a case where the portable device 20 requests the network data center 80 to send the software 60.

As shown in FIG. 3, in S100, the network service center 80 determines whether or not there is a request-to-send. In this example, it is determined whether or not the network service center 80 receives the request-to-send from the portable device 20. When there is the request-to-send, corresponding to YES in S100, the process proceeds to S110. When there is no request-to-send, the software sending process is ended, so that subsequent steps are not performed.

In S110, the network service center 80 performs an authentication process.

In the authentication process, the network service center 80 determines whether or not the portable device 20 is a legitimate device. In S120, the network service center 80 determines whether or not the authentication is successful. When the authentication is successful, corresponding to YES in S120, the process proceeds to S130. When the authentication is unsuccessful, corresponding to NO in S120, the software sending process is ended, so that subsequent steps are not performed.

In S130, the network service center 80 identifies the type of the connected device. Specifically, in S130, the type of the portable device 20 is identified based on referrer information transmitted from the portable device 20. In S140, the network service center 80 sends the software 60 according to the type of the portable device 20 identified in S130. Thereafter, the software sending process is ended.

In the above, the explanation was given on the software sending process when the portable device 20 requests the network data center 80 to send the software 60. However, the same can apply to a software sending process when the on-board device 10 requests the network data center 80 to send the software 30.

Through the above software sending process, the software 30 and the software 60, which implement functions of the on-board device 10 and the portable device 20, are installed in the on-board device 10 and the portable device 20.

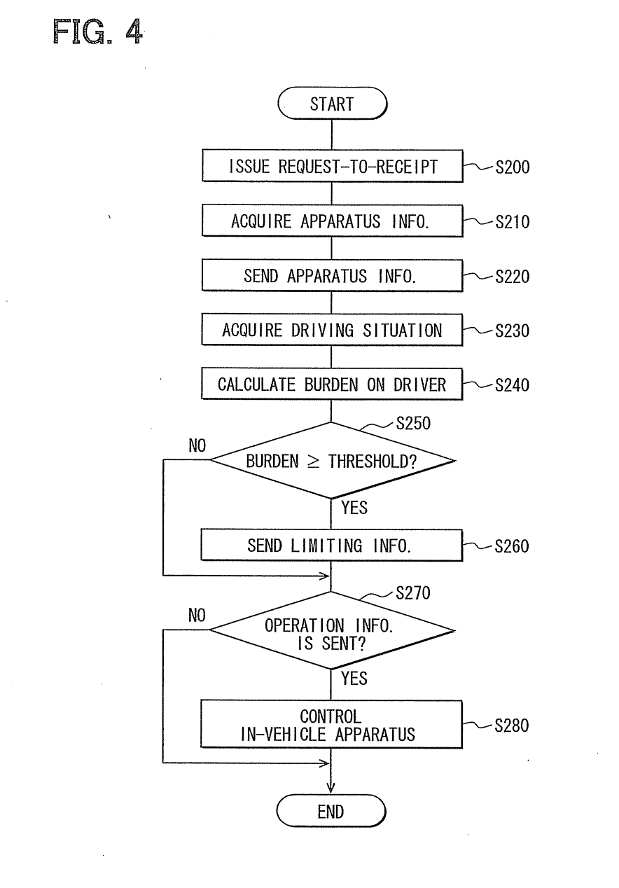

Next, an apparatus information sending process performed by the on-board device 10 will be described. FIG. 4 is a flowchart illustrating the apparatus information sending process. When a portable display mode is ON, the on-board device 10 periodically performs the apparatus information sending process. The portable display mode is a mode in which the information on the in-vehicle apparatus is displayed on the portable display 70.

As shown in FIG. 4, in S200, the on-board device 10 issues a request-to-receipt. Specifically, the on-board device 10 requests the portable device 20 to receive apparatus information, which is information on the in-vehicle apparatuses 40. In S210, the on-board device 10 acquires the apparatus information, which is information on the in-vehicle apparatuses 40. For example, the on-board device 10 acquires information on the navigation apparatus, the air conditioner, and the audio apparatus. Based on user's operation, the on-board device 10 may determine which apparatus information should be acquired

In S220, the on-board device 10 sends the apparatus information. Specifically, the on-board device 10 sends the apparatus information acquired in S210. In the above, the apparatus information displayed on the first, second and third in-vehicle displays 51 to 53 is excluded from the apparatus information to be sent to the portable device 20.

The on-board device 10 performing S210 and S220 may correspond the apparatus information sending section 31. In S230, the on-board device 10 acquires the information about a driving situation. As described, the information about a driving situation is inputted to the on-board device 10.

In S240, the on-board device 10 calculates the burden on the driver based on the driving situation acquired in S230. In the present embodiment, as described above, the environment situation detector includes the vehicle motion sensor for detecting a vehicle behavior, the acceleration sensor, and the physical/emotion condition sensor for detecting a driver's condition. Based on signals from these sensors, the burden on the driver is calculated as a numerical value.

In S250, the on-board device 10 determines whether or not the burden on the driver is greater than or equal to a threshold. When the burden is greater than or equal to a threshold, corresponding to YES in S250, the process proceeds to S260. In S260, the on-board device 10 sends restriction information (also called “limiting information”). The restriction information may include information for display restriction and may indicate a burden level in a stepwise fashion. Alternatively, the apparatus information acquired in S210 may be restricted according to the burden calculated in S240, and the restricted apparatus information may be sent as the restriction information. When it is determined that the burden is less than the threshold, corresponding to NO in S250, the process skips S260 and proceeds to S270.

The on-board device 10 performing S230 to S260 can correspond to the restriction information sending section 32. As described later, the portable device 20 displays information on the portable display 70 based on the apparatus information sent from the on-board device 10 and further based on, on an as-need-basis, the restriction information sent from the on-board device 10. When a user operates the portable device 20 based on the contents displayed on the portable display 70, the portable device 20 sends operation information to the on-board device 10 according to the user's operation.

In this relation, the on-board device 10 determines whether or not the operation information is sent. In other words, the on-board device 10 determines whether or not the on-board device 10 has received the operation information. When the operation information is sent and received, corresponding to YES in S270, the process proceeds to S280. In S280, the on-board device 10 controls the in-vehicle apparatuses 40 based on the received operation information. When the operation information is not sent, corresponding to NO in S270, the apparatus information sending process is ended.

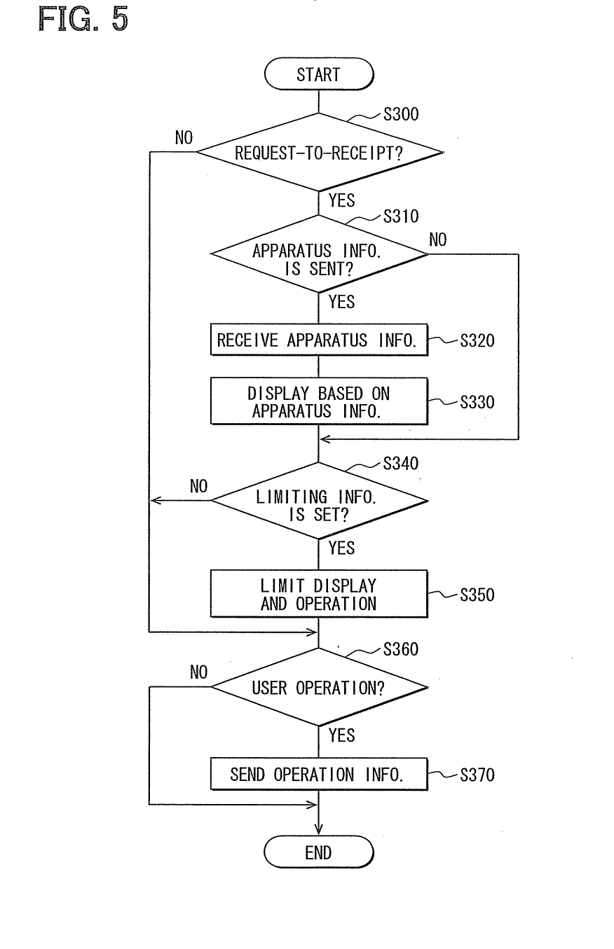

Next, an apparatus information receipt process performed by the portable device 20 will be described. FIG. 5 is a flowchart illustrating the apparatus information receipt process. The apparatus information receipt process corresponds to the apparatus information sending process performed by the on-board device 10.

In S300, the portable device 20 determines whether or not there is the request-to-receipt. Specifically, the portable device 20 determines whether or not the portable device 20 is requested to receive the apparatus information from the on-board device 10. S300 corresponds to S200 in FIG. 4. When there is the request-to-receipt, corresponding to YES in S300, the process proceeds to S310. When there is no request-to-receipt, corresponding to NO in S300, the apparatus information receipt process is ended, so that subsequent steps are not performed.

In S310, the portable device 20 determines whether or not the apparatus information is sent. Specifically, the portable device 20 determines whether or not the apparatus information is sent from the on-board device 10. When the apparatus information is sent, corresponding to YES in S310, the process proceeds to S320. When the apparatus information is not sent, corresponding to NO in S310, the process proceeds to S340.

In S320, the portable device 20 receives the apparatus information. Specifically, the apparatus information sent in S220 in FIG. 4 is received. In S330, the portable device 20 provides the display based on the apparatus information. Specifically, based on the apparatus information received in S320, the information on the in-vehicle apparatuses 40 is displayed on the portable display 70.

After S330 and after NO in S310, the process proceeds to S340. In S340, the portable device 20 determines whether or not the restriction information is sent. Specifically, the portable device 20 determines whether or not the portable device 20 has received the restriction information. This S340 corresponds to S260 in FIG. 4. When the restriction information is sent and received, corresponding to YES in S340, the process proceeds to S350. In S350, the portable device 20 restricts the display and the user operation. When the restriction information is not sent and not received, corresponding to NO in S340, the process skips S350 and proceeds to S360.

In S350, the display and the operation are restricted based on the restriction information. Specifically, when the restriction information includes burden information such as burden level or the like, the portable device 20 may restrict the display and the operation associated with the display based on the burden information. Alternatively, when the restriction information includes the apparatus information that was reconstructed according the burden level by the on-board device 10, the portable device 20 may perform an information display operation according to this reconstructed apparatus information.

The portable device 20 performing S310 to S350 may correspond to the portable display control section 63. In S360, the portable device 20 determines whether or not an operation based on the displayed information is conducted. Specifically, it is determined whether or not a user operates the portable device 20 based on the information displayed on the portable display 70 of the portable device 20. In the above, the user operation may be a user operation on the touch panel integrated with the portable display 70. Alternatively, the user operation may be a user operation on a switch (push button) of the portable device 20. When there is the user operation, corresponding to YES in S360, the process proceeds to S370. In S370, the portable device 20 sends the operation information indicative of the user operation, and thereafter, the apparatus information receipt process is ended. It should be noted that in response to the sending of the operation information, a determination result YES is given in S270 in FIG. 4. When it is determined that there is no user operation, corresponding to NO in S360, the apparatus information receipt process is ended.

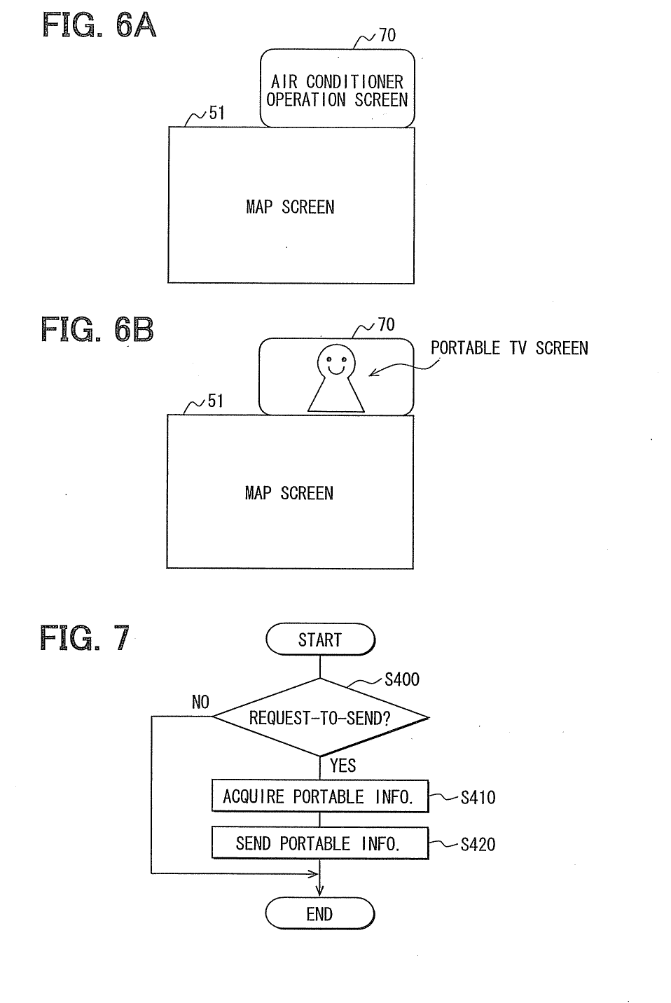

The portable device 20 performing S360 and S370 may correspond to the portable operation sending section 62. A concrete example will be described with reference to FIGS. 6A and 6B for facilitating understanding of the apparatus information sending process and the apparatus information receipt process shown in FIGS. 4 and 5.

The portable device 20 may acquire a map screen of the navigation apparatus and an operation screen of the air conditioner as the apparatus information (S210 in FIG. 4). The map screen of the navigation apparatus, which is a part of the acquired information, may be displayed on, for example, the first in-vehicle display 51. The operation screen of the air conditioner, which is the rest of the acquired information, may be sent to the portable device 20 (S220). When the operation screen of the air conditioner is sent (YES in S310), the portable device 20 receives the operation screen (S320) and displays the operation screen on the portable display 70 (S330). Accordingly, as shown in FIG. 6A, the map screen is displayed on the first in-vehicle display 51, and additionally, the air conditioner operation screen is displayed on the portable display 70.

In the above case, when the operation on the air conditioner operation screen is conducted through the portable display 70 of the portable device 20 (YES in S360 in FIG. 5), air conditioner operation information is sent (S370). In response, the on-board device 10 determines that the air conditioner operation information is sent (S270 in FIG. 4), and thereafter, the on-board device 10 controls the air conditioner, which is an example of the in-vehicle apparatus 40.

The on-board device 10 may acquire the driving situation (S230 in FIG. 4) and calculate the burden on the driver (S240). When the burden on the driver becomes greater than or equal to the threshold (YES in S250), the on-board device 10 sends the restriction information. In this case, the portable device 20 determines that the restriction information is sent (YES in S340), and thus, the portable device 20 restricts the display and the user operation thereon. For example, in the case of the air conditioner, the portable device 20 may prohibit the display of the air conditioner operation screen, or may prohibit the user operation on some of buttons of the air conditioner operation screen.

In FIG. 4, when the burden on the driver becomes greater than or equal to the threshold (YES in S250), the restriction information is sent (S260), provided that the apparatus information is sent (S220). Alternatively, regardless of whether or not the apparatus information is sent, the restriction information is sent (S260) based on the burden on the driver. For example, as shown in FIG. 6B, the portable display 70 may display a TV picture for a portable device. In this case, upon receipt of the restriction information from the on-board device 10, the portable device 20 may prohibit display of the portable TV picture for a potable device.

Next, a portable information sending process performed by the portable device 20 will be described. FIG. 7 is a flowchart illustrating the portable information sending process. When a portable display mode is ON, the portable device 20 cyclically performs the portable information sending process. The portable display mode is a mode in which information on the portable device is displayed on at least one of the in-vehicle displays 51 to 52 of the on-board device 10.

In S400, the portable device 20 determines whether or not there is a request-to-send. Specifically, the portable device 20 determines whether or not the on-board device 10 requests the portable device 20 to send the portable information. When there is the request-to-send, corresponding to YES in S400, the process proceeds to S410. When there is no request-to-send, the portable information sending process is ended, so that S410 and S420 are not performed.

In S410, the portable device 20 acquires the portable information. The portable information may be a TV picture for a portable device, news, a weather report, or the like. Alternatively, the portable information may be information stored in the portable device 20 such as an image or the like. The portable information to be acquired may be determined according to, for example, user operation.

In S420, the portable device 20 sends the portable information. Specifically, the portable device 20 sends the portable information acquired in S410 to the on-board device 10. After S420, the portable information sending process is ended.

The portable device performing S410 and S420 may correspond to the portable information sending section 61.

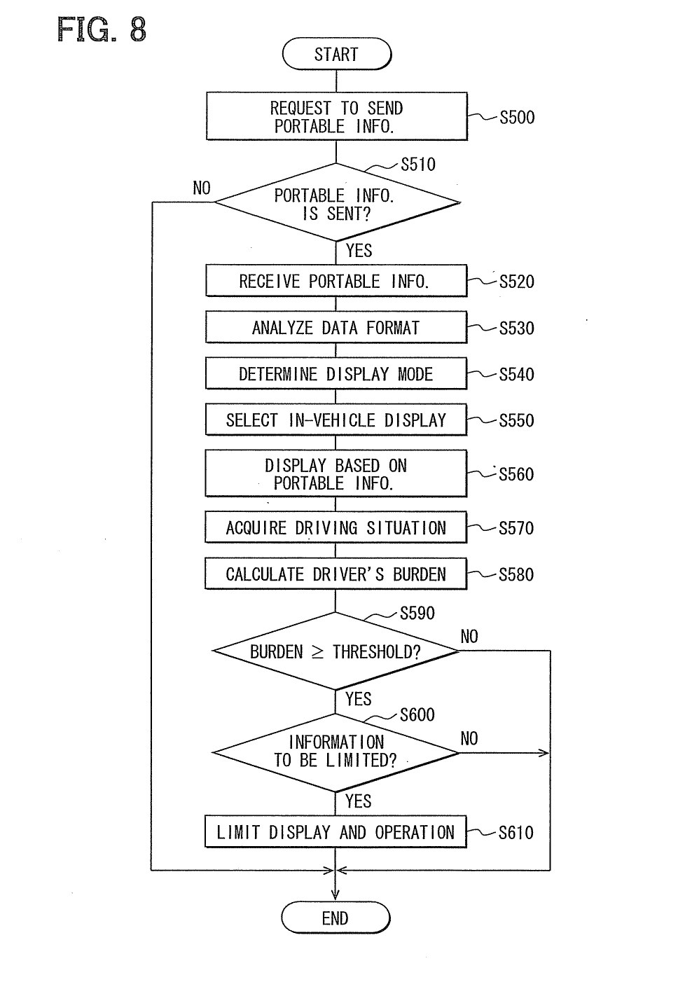

Next, a portable information receipt process performed by the on-board device 10 will be described. FIG. 8 is a flowchart illustrating the portable information receipt process. The portable information receipt process corresponds to the portable information sending process performed by the portable device 20.

In S500, the on-board device 10 issues a request to send the potable information. Specifically, the on-board device 10 requests the portable device 20 to send the portable information. In response to the request-to-send (YES in S400 in FIG. 7), the portable device 20 acquires the portable information (S410) and sends the portable information (S420).

In S510, the on-board device 10 determines whether or not the portable information is sent. Specifically, the on-board device 10 determines whether or not the portable information is sent from the portable device 20. S510 corresponds to S420. When it is determined that the portable information is sent, corresponding to YES in S510, the process proceeds to S520. When it is determined that the portable information is not sent, corresponding to NO in S510, the portable information receipt process is ended.

In S520, the on-board device 10 receives the portable information. In S530, the on-board device 10 analyzes a data format of the portable information. Specifically, the on-board device 10 performs S530 in order to display the information that matches the portable information. For example, the on-board device 10 may analyze whether or not the portable information is an urgent priority. Alternatively, the on-board device 10 may obtain the number of horizontal and vertical pixels needed to provide the information display.

In S540, the on-board device 10 determines which display mode should be used, based on a result of data format analysis in S530. In the present embodiment, the display mode includes a full screen mode, a side-by-side mode, and an overlap mode. In full screen mode, only the portable information is displayed on the screen as a whole. In the side-by-side mode, the portable information is displayed on a part of the screen and is placed side-by-side with the apparatus information. In the overlap mode, the portable information is displayed on a part of the screen so that the portable information is superimposed on the apparatus information. The display mode may be selected according to a total amount of information to be displayed.

In S550, based on a result of data format analysis in S530, the on-board device 10 selects one of the multiple in-vehicle displays 51 to 53 that is suited for the information display. For example, when the portable information is urgent information, the on-board device 10 selects one of the multiple in-vehicle displays 51 to 53 that is installed at a most noticeable place for the driver. Alternatively, the on-board device 10 may select one of the multiple in-vehicle displays 51 to 53 that is most suited to display the portable information in term of, for example, the number of horizontal and vertical pixels.

In S560, the display based on the portable information is provided. Specifically, in the display mode selected in the S540, the portable information is displayed on the in-vehicle display 51 to 53 selected in S550.

In S570, the on-board device 10 acquires the driving situation. S570 is substantially the same as S230 in FIG. 4. In S580, the on-board device 10 calculates the burden on the driver. S580 is substantially the same as S240 in FIG. 4.

In S590, the on-board device 10 determines whether or not the burden on the driver is greater than or equal to the threshold. When the burden on the driver is greater than or equal to the threshold, corresponding to YES In S590, the process proceeds to S600. When the burden on the driver is less than the threshold, corresponding to NO in S590, the portable information receipt process is ended.

In S600, the on-board device 10 determines whether or not the portable information is the information to be restricted. Specifically, the portable information may include a variety of information which may be classified into first information on which the driver is likely to fix his or her eyes and second information on which the driver is unlikely to fix his or her eyes. Thus, when the driving burden on the drive is high, the display of the first information and the operation on the first information should be restricted from a safety viewpoint. As for the second information, regardless of the driving burden on the drive, it would not matter if the display of the second information and the operation were allowed. The first information may be, for example, an incoming mail. The second information may be, for example, a weather report. When the on-board device 10 determines that the portable information is the information to be restricted (YES in S60), the process proceeds to S610. In S610, the on-board device 10 restricts the display and the operation that are based on the portable information. Thereafter, the portable information receipt process is ended. When the on-board device 10 determines that the portable information is not the information to be restricted. The portable information receipt process is ended.

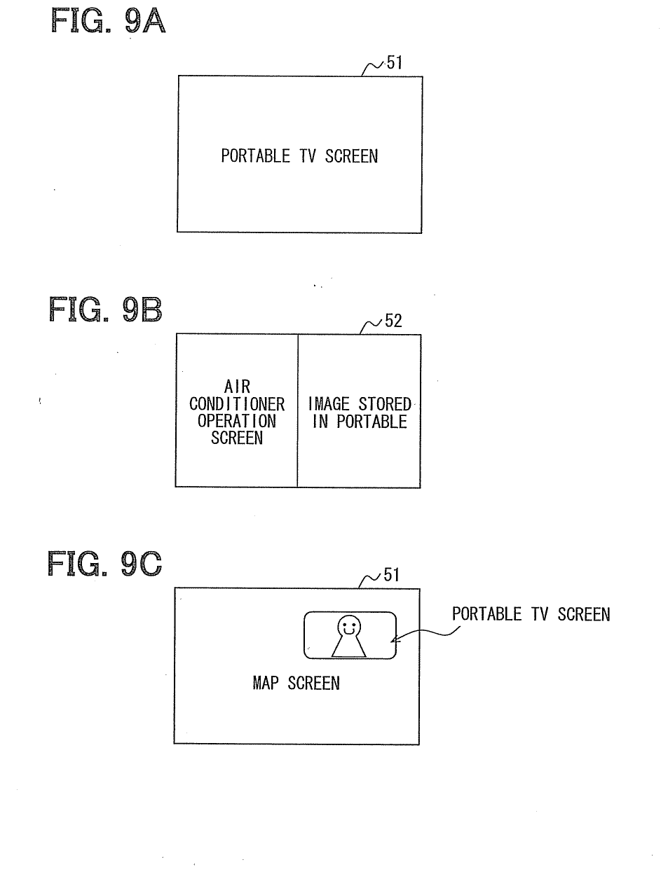

The on-board device 10 performing S510 to S610 may correspond to the vehicle display control section 33. A concrete example will be described with reference to FIGS. 9A to 9C for facilitating understanding of the portable information sending process and the portable information receipt process shown in FIGS. 7 and 8.

The portable device 20 may acquire, as the portable information, the TV screen on the portable device 20 and the image stored in the portable device 20 (S410). The portable device 20 sends the portable information to the on-board device 10 (S420). In response, the on-board device 10 receives the portable information, which is the portable TV picture and the portable image in this example, from the portable device (S520), and analyzes a data format of each information (the portable TV picture and the portable image). Then, the portable device 20 determines the display mode (S540), selects which in-vehicle display 51 to 53 displays the portable information (S550), and provides the display based on the portable information (S560).

For example, as shown in FIG. 9A, the portable TV picture may be displayed on the whole first in-vehicle display 51. Alternatively, as shown in FIG. 9B, the air conditioner operation screen serving as the operation information may be displayed on a left half of the second in-vehicle display 52, and additionally, the image stored in the portable device 20 may be displayed on a right half of the second in-vehicle display 52. Alternatively, as shown in FIG. 9C, when the map screen serving as the apparatus information is displayed on the first in-vehicle display 51, the portable TV screen may be superimposed on a part of the map screen.

The on-board device 10 acquires the driver situation (S570 in FIG. 8), and calculates the burden on the driver (S580). When the burden on the driver becomes greater than or equal to the threshold, the on-board device 10 determines whether or not the portable information is the information to be restricted (S600). When the portable information is the information to be restricted (YES in S600), the display and the portable-information-based user-operation are restricted (S610). For example, in the case of the portable TV screen, when the burden on the driver is large, the display of the portable TV screen is prohibited, and only its sound is outputted.

Advantages of the information display system 1 of the present embodiment will be described. In the present embodiment, the on-board device 10 acquires the apparatus information, which is information on the in-vehicle apparatuses 40 (S210). The on-board device 10 sends the acquired apparatus information to the portable device 20. In response to sending the apparatus information (YES in 310), the portable device 20 receives the apparatus information (S320), and displays the apparatus information on the portable display 70 (S330). That is, on the promise that the portable device 20 includes the portable display 70, the apparatus information can be displayed with use of the portable display 70. Because of this, without requiring a user to purchase an in-vehicle display, it is possible to provide the information to a user in a vehicle in an efficient manner.

In the present embodiment, the vehicle is equipped with the first, second and third in-vehicle displays 51 to 53. The on-board device 10 displays a part of the acquired apparatus information on the first, second and third in-vehicle displays 51 to 53, and sends the rest of the acquired apparatus information to the portable device 20. Because of this, the apparatus information is displayed on both of the in-vehicle displays 51 to 53 and the portable display 70. Thus, the user operation of display switching can be reduced as compared with a case where either the in-vehicle displays 51 to 53 or the portable display 70 is used to display the apparatus information. Moreover, since the portable display 70 is added to the pre-mounted in-vehicle displays 51 to 53, a sufficient amount of information can be provided.

In the present embodiment, it is determined whether or not the user operation based on the display of the portable display 70 is conducted (S360 in FIG. 5). When the user operation based on the display of the portable display 70 is conducted (YES in S360), the portable device 20 sends the operation information to the on-board device 10 (S370). In response, the on-board device 10 controls the in-vehicle apparatus 40 based on the sent operation information (S270, S280). Therefore, the user can control the in-vehicle apparatus 40 by operating the portable device 20. Usability improves.

Moreover, in the present embodiment, the on-board device 10 acquires the driving situation (S230), and calculates the driver's burden (S240). When the driver's burden in driving the vehicle becomes greater than or equal to the threshold (YES in S250), the on-board device 10 sends the restriction information. In response to the sending of the restriction information (S340), the portable device 20 restricts the display and operation. Because of this, the display and the user operation on portable device 20 based on the display are restricted according to the driving situation. Thus, it is possible to provide the information while taking a care to ensue safety.

Moreover, in the present embodiment, the portable device 20 acquires the portable information (YES in S400), and sends the portable information to the on-board device 10 (S420). In response, the on-board device 10 receives the portable information (S520), and displays the portable information by using al least one of the first, second and third in-vehicle displays 51 to 53 (S560). Because of this, the portable information can be also displayed on the in-vehicle displays 51 to 53. Thus, a manner of providing the information to a user in a vehicle can be improved and enriched.

Furthermore, the on-board device 10 acquires the driving situation (S570). When the driver's burden in driving the vehicle becomes greater than or equal to the threshold (S580, YES in S590), the display and the user operation based on the portable information are restricted. Since the display and the display-based user-operation are restricted according to the driving situation, it is possible to provide the information while taking a care to ensure safety.

Furthermore, the on-board device 10 determines whether or not the received portable information is the information to be restricted (S600). When the received portable information is the information to be restricted (YES in S600), the display and operation based on the received portable information are restricted (S610). Since the display and the display-based user-operation are restricted according to the driving situation, and since the display is further restricted according to type of the portable information, the advantage of providing the information by taking a care to ensure the safety can be further enhanced.

Moreover, in the present embodiment, in order to provide the portable information by using the in-vehicle displays 51 to 53, the on-board device 10 analyzes the data format of the portable information (S530), so that the portable information can be displayed on a part of the in-vehicle displays 51 to 53 as well as the apparatus information is displayed on the in-vehicle displays 51 to 53. Because of this, the portable information can be appropriately displayed with use of the in-vehicle displays 51 to 53. The number of required screen switching becomes small. An information providing manner in a vehicle is sophisticated.

Moreover, in the present embodiment, in order to provide the portable information by using the in-vehicle displays 51 to 53, the on-board device 10 analyzes the data format of the portable information (S530), so that the portable information can be displayed on one of the in-vehicle displays 51 to 53 that is suited to display the portable information. Because of this, the portable information can be appropriately displayed with use of the in-vehicle displays 51 to 53. The in-vehicle displays 51 to 53 can be used efficiently.

Moreover, in the present embodiment, both of the on-board device 10 and the portable device 20 can perform data communications with the network data center 80 to download the software 30 for the on-board device 10 and the software 60 for the portable device 20 from the network data center 80 (see FIGS. 2 and 3). Because of this, the software 30 and the software can be installed easily.

The apparatus information sending section 31 can correspond to an apparatus information sending means. The restriction information sending section 32 can correspond to a restriction information sending means. The vehicle display control section 33 can correspond to a vehicle display control means. The portable information sending section 61 can correspond to a portable information sending means. The portable operation sending section 62 can correspond to a portable operation sending means. The portable display control section 63 can correspond to a portable display control means.

Other embodiments will be described.

In the above embodiment, the software 30 for the on-board device 10 and the software 60 for the portable device 20 are downloaded from the network data center 80. Alternatively, when the portable device 20 is connected to the on-board device 10, the software 60 for the portable device 20 may be downloaded from the on-board device 10. A software sending process in this case may be substantially the same as that shown in FIG. 3. In this configuration, when the portable device 20 is carried into a vehicle compartment and is connected to the on-board device 10, the portable device 20 can participate in the information display system 1 even if the software 60 for the portable device 20 is not installed in the portable device 20 in advance. Usability improves.

Each of the software 30 for the on-board device 10 and the software 60 for the portable device 20 may include multiple software components such as manage-ware, application and the like.

The present disclosure has various aspects. For example, according to one aspect, an information display system comprising an on-board device and a portable device is provided. The on-board device is configured to control a plurality of in-vehicle apparatuses. The portable device includes a portable display. The on-board device and the portable device are configured to communicate with each other for data exchange. The plurality of in-vehicle apparatuses controlled by the on-board device may include a navigation apparatus, an air conditioner, an audio apparatus, or the like. The portable device may include a cellular phone such as a smart phone or the like. For example, the portable device may be a personal digital assistance (PDA) or the like.

In the information display system, the on-board device includes an apparatus information sending section configured to send apparatus information, which is information on the plurality of in-vehicle apparatuses. The portable device includes a portable display control section configured to display the apparatus information, which is sent from the apparatus information sending section, on the portable display.

Specifically, in the information display system, on the promise that the portable device includes the portable display, the apparatus information can be displayed with use of the portable display. Because of this, the information display system can provide information without requiring new purchases of an in-vehicle display. In this system, if an in-vehicle display is pre-installed in a vehicle, the portable display can be an additional display, and thus, a sufficient amount of information can be provided to a user.

Not only the portable device displays the apparatus information, but it may be preferable that a user can operate the in-vehicle apparatuses with use of the portable device. In view of this, the above information display system may be configured as follows. The portable device further includes a portable operation sending section. In response to user operation on the portable device that is based on contents displayed on the portable display, the portable operation sending section sends operation information, which is information on the user operation on the portable device. Based on the operation information sent from the portable device, the on-board device controls the plurality of in-vehicle apparatuses. Because of this, a user can control the in-vehicle apparatuses by operating the portable device. High usability can be achieved.

It may be preferable that a care be taken to ensure safety when information is provided to a user in a vehicle. Thus, it may be necessary to provide information in accordance with a driving situation (e.g., a vehicle traveling condition). In view of this, the information display system may be configured as follows. The on-board device further includes a restriction information sending section configured to send restriction information according to a driving situation. Based on the restriction information sent from the restriction information sending section, the portable display control section of the portable device restricts at least one of display on the portable display and the user operation on the portable device.

The driving situation herein refers to a comprehensive concept including a burden on a driver. The burden on a driver may be estimated from vehicle behavior, motion of the driver's eyelid, motion of the diver's line of sight, heart rate of the driver, and/or the like.

According to the above configuration, the display and the use operation based on the display can be restricted according to the driving situation. Therefore, while taking the care of safety, it is possible to efficiently provide the information to a user.

The above information display system may be configured to display the portable information, which is information on the portable device, on the in-vehicle display as well as displaying the apparatus information on the portable display. Specifically, the above information display system may be configured as follows. The portable device further includes a portable information sending section configured to send portable information, which is information on the portable device. The on-board device is mounted to a vehicle that is equipped with at least one in-vehicle display. The on-board device further includes an in-vehicle display control section configured to display the portable information, which is sent from the portable information sending section, on the in-vehicle display. According to this configuration, since the portable information can be displayed on the in-vehicle display, a manner of providing the information to a user in a vehicle can be improved and enriched.

In the above information display system, the vehicle display control section may restrict at least one of display on the in-vehicle display and the user operation in accordance with the driving situation. In the above, the restricted user operation is the user operation that is based on the display on the in-vehicle display. According to this configuration, since the display on the in-vehicle display and the user operation based on the display are restricted in accordance with the driving situation, it is possible to efficiently provide the information to a user while taking a care of safety.

The portable information may include a variety of information associated with functions of the portable device. For example, the portable information may be a TV picture for a portable device, an image (including static image and moving image) stored in the portable device, a news or weather report retrieved by the portable device, or the like.

In view of this, the above information display system may be configured as follows. Based on type of the portable information, the vehicle display control section restricts the at least one of the display on the in-vehicle display and the user operation in accordance with the driving situation. According to this configuration, since the display on the in-vehicle display and the user operation based on the display are restricted according to driving situation and further restricted according to the type of the portable information. The advantage of providing the information to a user while taking a care of safety can be further enhanced.

The in-vehicle display may usually display a map of the navigation apparatus. Thus, the vehicle display control section displays the portable information on a part of the in-vehicle display as well as displaying the apparatus information. For example, a weather report may be displayed side by side with the map. Alternatively, a weather report may be superimposed on a part of the map. According to the above configuration, the user needs not switch the display screen. A manner of providing the information to a user in a vehicle can be improved and enriched.

The vehicle may be equipped with a plurality of in-vehicle displays. In this case, the vehicle display control section may display the portable information on one of the plurality of in-vehicle displays that is most suited to display the portable information. According to this configuration, the plurality of in-vehicle displays can be efficiently used.

The above information display system may be configured as follows. The in-vehicle display control section displays the portable information on the in-vehicle display based on a data format of the portable information. For example, the in-vehicle display control section may acquire the number of horizontal and vertical pixels from the data format to display the portable display on the in-vehicle display. According to this configuration, the portable information can be displayed on the in-vehicle display in an appropriate manner.

When the vehicle is equipped with an in-vehicle display, the apparatus information sending section of the on-board device may send a part of the apparatus information to the portable device and may display the rest of the apparatus information on the in-vehicle display. According to this configuration, since the apparatus information can be displayed on both of the in-vehicle display and the portable display, a user operation for switching display screen can be reduced as compared with a case where one of the in-vehicle display and the portable display is used to display the apparatus information.

A function of each section of the on-board device may be implemented by software. For example, the on-board device may acquire the software, which implements the function of each section of the on-board device, via a network data center. Likewise, a function of each section of the portable device may be implemented by software. Thus, the portable device may acquire the software, which implements a function of each section of the portable device, via the on-board device or the network data center. According to the above configuration, the software for implementing the each section can be easily installed.

The above advantages may be achieved by the on-board device. Likewise, the above advantages may be achieved by the portable device.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. An information display system comprising:
an on-board device configured to control a plurality of in-vehicle apparatuses; and
a portable device including a portable display,
wherein:
the on-board device and the portable device are configured to communicate with each other for data exchange;
the on-board device includes
an apparatus information sending section configured to send apparatus information, which is information on the plurality of in-vehicle apparatuses; and
the portable device includes
a portable display control section configured to display the apparatus information, which is sent from the apparatus information sending section, on the portable display.

2. The information display system according to claim 1, wherein:
the portable device further includes a portable operation sending section;
in response to user operation on the portable device that is based on contents displayed on the portable display, the portable operation sending section sends operation information, which is information on the user operation on the portable device; and
the on-board device controls the plurality of in-vehicle apparatuses based on the operation information, which is sent from the portable device.

3. The information display system according to claim 1, wherein:
the on-board device further includes
a restriction information sending section configured to send restriction information according to a driving situation; and
based on the restriction information sent from the restriction information sending section, the portable display control section of the portable device restricts at least one of display on the portable display and the user operation on the portable device.

4. The information display system according to claim 1, wherein:
the portable device further includes
a portable information sending section configured to send portable information, which is information on the portable device;
the on-board device is mounted to a vehicle that is equipped with at least one in-vehicle display; and
the on-board device further includes
an in-vehicle display control section configured to display the portable information, which is sent from the portable information sending section, on the in-vehicle display.

5. The information display system according to claim 4, wherein:
the vehicle display control section restricts at least one of display on the in-vehicle display and the user operation in according with a driving situation; and
the restricted user operation is the user operation that is based on the display on the in-vehicle display.

6. The information display system according to claim 5, wherein:
based on type of the portable information, the vehicle display control section restricts the at least one of the display on the in-vehicle display and the user operation in accordance with the driving situation; and

7. The information display system according to claim 4, wherein:
as well as displaying the apparatus information, the vehicle display control section displays the portable information on a part of the in-vehicle display.

8. The information display system according to claim 4, wherein:
the at least one in-vehicle display equipped in the vehicle is a plurality of in-vehicle displays; and
the vehicle display control section displays the portable information on one of the plurality of in-vehicle displays that is most suited to display the portable information.

9. The information display system according to claim 4, wherein:
the in-vehicle display control section displays the portable information in accordance with a data format of the portable information.

10. The information display system according to claim 4, wherein:
the apparatus information sending section of the on-board device sends a part of the apparatus information to the portable device while displaying the rest of the apparatus information on the in-vehicle display.

11. The information display system according to claim 1, wherein:
the on-board device acquires software, which implements a function of each section of the on-board device, via a network data center.

12. The information display system according to claim 1, wherein:
the portable device acquires software, which implements a function of each section of the portable device, via the on-board device or a network data center.

13. The on-board device of the information display system of claim 1.

14. The portable device of the information display system of claim 1.
